(19) United States
(12) Patent Application Publication
(10) Pub. No.: US 2011/0035494 A1
(43) Pub. Date: Feb. 10, 2011

(54) NETWORK VIRTUALIZATION FOR A VIRTUALIZED SERVER DATA CENTER ENVIRONMENT

(75) Inventors: Vijoy Pandey, San Jose, CA (US); Rakesh Saha, San Jose, CA (US); TienWei Chao, San Jose, CA (US); Wayming Daniel Tai, Cupertino, CA (US); Dar-ren Leu, San Jose, CA (US); Thiennga Hoang, San Jose, CA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: BLADE NETWORK TECHNOLOGIES, Santa Clara, CA (US)

(21) Appl. No.: 12/937,206

(22) PCT Filed: Apr. 14, 2009
(86) PCT No.: PCT/US09/40416

§ 371 Date: Oct. 8, 2010

Related U.S. Application Data
(60) Provisional application No. 61/044,950, filed on Apr. 15, 2008.

(51) Int. Cl. G06F 15/173

(52) U.S. Cl. 709/224

(57) ABSTRACT

A data center includes a physical host machine operating a virtualized entity and a network switch having a physical port connected to the physical host machine. To configure the network switch, the network switch has a management module that acquires information about the virtualized entity operating on the physical host machine. The network switch associates the acquired information about the virtualized entity with the physical port, assigns the virtualized entity to a group associated with a traffic-handling policy, and processes packet traffic from the virtualized entity in accordance with the traffic-handling policy. The virtualized entity can be, for example, a virtual machine or a multi-queue network input/output adapter operating on the physical host machine.

### RELATED APPLICATION

This application claims the benefit of U.S. Provisional Patent Application No. 61/044,950, filed on Apr. 15, 2008, the entirety of which application is incorporated by reference herein.

### FIELD OF THE INVENTION

The invention relates generally to network switches. More particularly, the invention relates to network switches for use in a virtualized server data center environment.

### BACKGROUND

Server virtualization in data centers is becoming widespread. In general, server virtualization describes a software abstraction that separates a physical resource and its use from the underlying physical machine. Most physical resources can be abstracted and provisioned as virtualized entities. Some examples of virtualized entities include the central processing unit (CPU), network input/output (I/O), and storage I/O.

Virtual machines (VM), which are a virtualization of a physical machine and its hardware components, play a central role in virtualization. A virtual machine typically includes a virtual processor, virtual system memory, virtual storage, and various virtual devices. A single physical machine can host a plurality of virtual machines. Guest operating systems execute on the virtual machines, and function as though executing on the actual hardware of the physical machine.

A layer of software provides an interface between the virtual machines resident on a physical machine and the underlying physical hardware. Commonly referred to as a hypervisor or virtual machine monitor (VMM), this interface multiplexes access to the hardware among the virtual machines, guaranteeing to the various virtual machines use of the physical resources of the machine, such as the CPU, memory, storage, and I/O bandwidth.

Typical server virtualization implementations have the virtual machines share the network adapter or network interface card (NIC) of the physical machine for performing external network I/O operations. The hypervisor typically provides a virtual switched network (called a vswitch) that provides interconnectivity among the virtual machines. The vswitch interfaces between the NIC of the physical machine and the virtual NICs (vNICs) of the virtual machines, each virtual machine having one associated vNIC. In general, each vNIC operates like a physical NIC, being assigned a media access control (MAC) address that is typically different from that of the physical NIC. The vswitch performs the routing of packets to and from the various virtual machines and the physical NIC.

Advances in network I/O hardware technology have produced multi-queue NICs that support network virtualization by reducing the burden on the vswitch and improving network I/O performance. Generally, multi-queue NICs assign transmit and receive queues to each virtual machine. The NIC places outgoing packets from a given virtual machine into the transmit queue of that virtual machine and incoming packets addressed to the given virtual machine into its receive queue. The direct assignment of such queues to each virtual machine thus simplifies the handling of outgoing and incoming traffic. As used herein, a virtualized server or host is a physical server or host in which either virtual machines, multi-queued NICs, or both have been deployed; a non-virtualized server or host is physical server lacking both such virtualization technologies.

In a non-virtualized server environment, the network interface of each physical server (i.e., a single or multi-homed host) is directly connected to one port of a network switch. Therefore, in a non-virtualized environment, a port-based switch configuration on the network switch implicitly and directly corresponds to a physical host-based switch configuration. Thus, network policies that are to apply to a certain physical host are assigned to a particular port on the network switch.

This model succeeds in a non-virtualized host environment, but breaks down in a virtualized host environment because physical host machines, and thus network switch ports, no longer have a one-to-one mapping to servers or services. The virtualization of a physical host machine that can simultaneously run multiple virtual machines changes the traditional networking model in the following ways:

(1) Each virtual machine can run a full featured operating system and requires configuration and management, and because one physical host machine can support many virtual machines, the network configuration and administration effort per physical host machine increases significantly;

(2) Each multi-queued NIC can be provisioned into multiple virtual NICs and can be configured as multiple NICs within an operating system running in a non-virtualized host environment or within a virtual machine; and

(3) To provide network management of the various virtual machines hosted by a single hypervisor running on a single physical host machine, the hypervisor provides a virtual switch that provides connectivity between the various virtual machines running on the same physical host machine.

Consequent to these characteristics of virtualization, a physical port of the network switch no longer suffices to uniquely identify the servers or services of a physical host machine because now multiple virtual machines or multiple queues of a multi-queue NIC are connected to that single physical port.

### SUMMARY

In one aspect, the invention features a data center comprising a first physical host machine operating one or more virtualized entities and a second physical host machine operating one or more virtualized entities. A network switch has a first physical port connected to the first physical host machine, a second physical port connected to the second physical host machine, and a management module that acquires information about each virtualized entity operating on the physical host machines. The management module uses the information to associate each virtualized entity with the physical port to which the physical host machine operating that virtualized entity is connected. The management module also assigns each virtualized entity to a group and associates each group with a traffic-handling policy. A switching fabric processes packet traffic received from each of the virtualized entities based on the traffic-handling policy associated with the group assigned to that virtualized entity.

In another aspect, the invention features a data center comprising a physical host machine operating a virtualized entity and a network switch having a physical port connected to the physical host machine. The network switch has a management module that acquires information about the virtualized entity operating on the physical host machine and uses the information to associate the virtualized entity with the physical port and to detect when packet traffic arriving at the network switch is coming from the virtualized entity.

In yet another aspect, the invention features a network switch comprising a physical port connected to a physical host machine that is operating a virtualized entity and a management module in communication with the physical host machine through the physical port. The management module acquires information about the virtualized entity operating on the physical host machine and uses the information to associate the virtualized entity with the physical port and to detect when ingress packet traffic is coming from the virtualized entity.

In still another aspect, the invention features a method of configuring a network switch to process packet traffic from a virtualized entity operating on a physical host machine connected to a physical port of the network switch. The network switch acquires information about the virtualized entity operating on the physical host machine, associates the acquired information about the virtualized entity with the physical port, assigns the virtualized entity to a group associated with a traffic-handling policy, and processes packet traffic from the virtualized entity in accordance with the traffic-handling policy.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an embodiment of a data center with a physical host machine, having a virtualized entity, in communication with a network switch.

FIG. 2A, FIG. 2B, and FIG. 2C are diagrams of different embodiments of virtualized host environments.

FIG. 3 is a functional block diagram of an embodiment of the network switch.

FIG. 4 is a flow diagram of an embodiment of a process for configuring the network switch to be aware of virtualized entities operating on physical host machines.

FIG. 5 is a block diagram of an embodiment of a data center with three physical host machines, each running one or more virtual machines, in communication with the network switch.

FIG. 6A, FIG. 6B, and FIG. 6C are diagrams of embodiments of data structures that can be used to associate downlink ports to virtual machines, virtual machines to groups, and groups to uplink ports.

FIG. 7 is a flow diagram of an embodiment of process for handling a packet, originating from a virtualized entity, based on the group assigned to the virtualized entity.

FIGS. 8A and 8B are diagrams of the format of 802.1q and 802.1q-in-q packets that can convey the identity of the group assigned to the virtualized entity issuing the packet.

FIG. 9 is a diagram of an embodiment of a data center with three physical host machines, each having a different set of virtualized entities, in communication with the network switch.

FIG. 10 is a diagram of an embodiment of a data center including a plurality of physical host machines, first and second network switches, an aggregator switch, and an optional gateway switch.

### DETAILED DESCRIPTION

Data centers described herein extend virtualization beyond the server-network boundary, from the physical host machines (or servers) into the network switches. Such network switches are “virtualization-aware”. As used herein, a network element that is virtualization-aware generally means that the network element “sees” the virtualized host environment of a physical host machine, by learning of the existence and identities of one or more virtualized entities (VEs) on the physical host machine, and can detect, monitor, and control packet traffic to and from those virtualized entities. Examples of virtualized entities described herein include virtual machines (VMs) and multi-queued network I/O adapters (also called multi-queue NICs).

Through the network switch, an administrator can place these virtualized entities into groups (referred to herein as VE groups), irrespective of the physical host machine upon which the virtualized entities operate. To maximize management granularity and flexibility, membership in a VE group can be as small as a single physical host machine, a single virtual machine, or a single queue of a multi-queue NIC. Data centers can also have a mixed variety of VE groups; for example, the network switches can simultaneously manage VE groups established at the VE granularity and at the physical host machine granularity.

The network switch also associates each group with a traffic-handling policy. For example, the network element can assign access control lists (ACLS), quality of service (QoS), and VLAN membership at the VE group level. This grouping of virtualized entities also facilitates the control of network resource allocation; each VE group can have dedicated network resources. For example, the network switch assigns each group to a particular physical uplink port of the network switch. To network elements upstream of the network switch, this uplink connectivity causes the network switch to appear as a multi-home NIC.

The network switch processes the packet traffic of each virtualized entity in accordance with the traffic-handling policy associated with the group to which that virtualized entity is assigned. Thus, the grouping, associated traffic-handling policy, and allocated network resources are a function of the virtualized entities, and not a function of the physical downlink ports of the network switch.

In addition, the grouping of virtualized entities can serve to isolate virtualized entities in one group from virtualized entities in another group, thereby maintaining service-oriented security for network traffic across VE groups. When a virtual machine moves from one physical host machine to another physical host machine, the traffic-handling policy associated with that virtual machine (e.g., the ACL, QoS, and VLAN assignments) moves with it. The particular physical location in the data center to which the virtual machine moves is of no consequence; the virtual machine remains a member of its assigned group and continues to undergo the traffic-handling policy and receive the allocated network resources associated with that group.

The ability to monitor and manage packet traffic at a VE granularity also facilitates service level agreement (SLA) configuration; an administrator can provision virtualized entities on a physical host machine to accommodate distinct and disjoint SLAs, and the grouping of such virtualized entities can be established so that the distinct SLAs can be individually serviced.

A virtualization-aware network switch can also implement redundancy and failover operations based on VE-granular groups. Service-level and application-aware health checks to support failover and redundancy can likewise occur at the VE-granular level, not just at the physical hardware level.

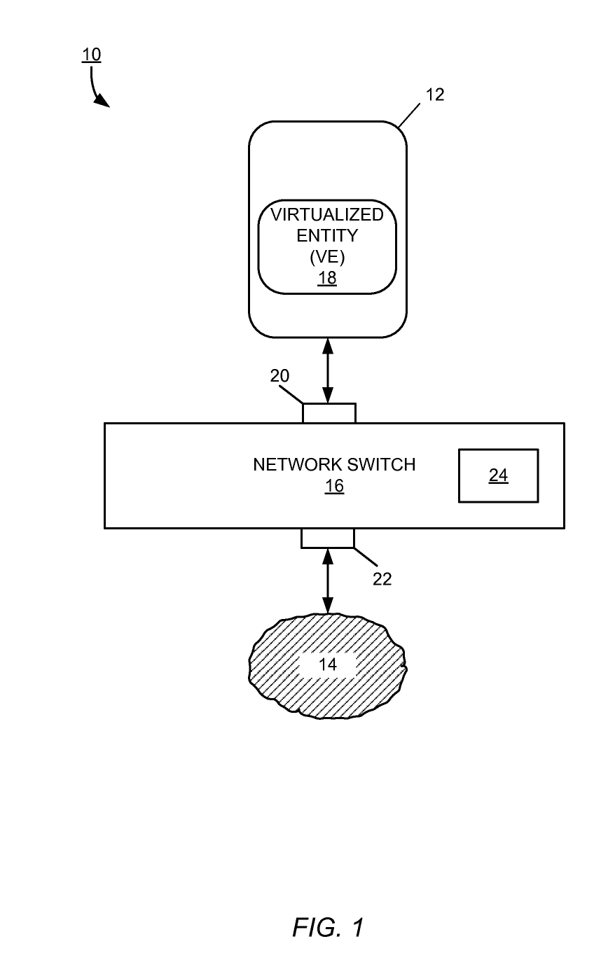

FIG. 1 shows an embodiment of an oversimplified data center 10 including a physical host machine 12 in communication with a network 14 through a network switch 16. As used herein, a data center is a location that serves as a computational, storage, and networking center of an organization. The equipment of a data center can reside together locally at a single site or distributed over two or more separate sites. The network 14 with which the physical host machine 12 is in communication can be, for example, an intranet, an extranet, the Internet, a local area network (LAN), wide area network (WAN), or a metropolitan area network (MAN).

The physical host machine 12 is an embodiment of a physical server, such as a server blade. The physical host 12 includes hardware (not shown) such as one or more processors, memory, input/output (I/O) ports, network input/output adapter (i.e., network interface card or NIC) and, in some embodiments, one or more host bus adaptors (HBA). The physical host machine 12 can reside alone or be stacked within a chassis with other physical host machines, for example, as in a rack server or in a blade server. In general, the physical host machine 12 provides a virtualized host environment that includes a virtualized entity (VE) 18.

The oversimplified embodiment of the network switch 16 shown in FIG. 1 includes one downlink port 20 and one uplink port 22. (Normally, network switches have more than one downlink port and more than one uplink port, but only one port of each type is shown here to simplify the description.) The network switch 16 generally is a network element that performs packet switching between downlink and uplink ports. The physical host machine 12 is directly connected to the downlink port 20, whereas the network 14 is connected to the uplink port 22. The network switch 16 can reside alone or be stacked within the same equipment rack or chassis as the physical host machine 12.

The network switch 16 includes a management module 24, through which the network switch 16 is configured to be “virtualization-aware”. An Ethernet switch is an example of one implementation of the network switch 16. In one embodiment, the virtualization-aware network switch is implemented using a Rackswitch™ G8124, a 10 Gb Ethernet switch manufactured by Blade Network Technologies, Inc. of Santa Clara, Calif.

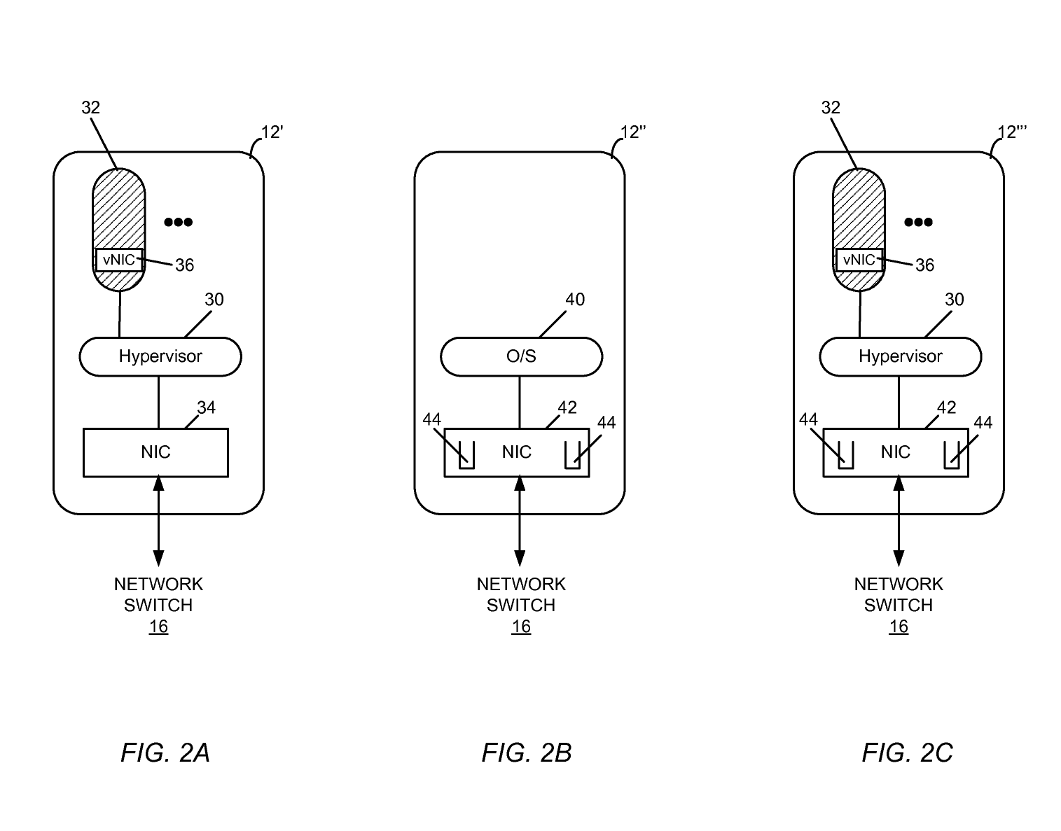

Three different examples of embodiments of virtualized host environments that can be provided by a physical host machine appear in FIG. 2A, FIG. 2B, and FIG. 2C. In FIG. 2A, a physical host machine 12′ has virtualization software, which includes hypervisor software 30 for abstracting the hardware of the physical host machine 12′ into one or more virtual machines 32. The hypervisor 30 is in communication with a NIC 34, which handles the network I/O to and from the network switch 16. In this embodiment, each virtual machine 32 and the hypervisor are examples of virtualized entities 18 (FIG. 1).

An example of virtualization software for implementing virtual machines on a physical host machine is VMware ESX Server™, produced by VMware® of Palo Alto, Calif. Other examples of virtualization software that can be used in conjunction with virtualization-aware network switches include XenSource™ produced by Citrix of Ft. Lauderdale, Fla., and Hyper-V™ produced by Microsoft of Redmond, Wash., Virtuozzo™ produced by SWsoft of Herndon, Va., and Virtual Iron produced by Virtual Iron Software of Lowell, Mass. Advantageously, the virtualization-aware network switches described herein can detect, group, and manage virtualized entities irrespective of the particular brand of virtualization software running on any given physical host machine.

Each virtual machine 32 includes at least one application (e.g., a database application) executing within its own guest operating system. Generally, any type of application can execute on a virtual machine. In addition, each virtual machine 32 has an associated virtual NIC (vNIC) 36, with each vNIC 36 having its own unique virtual MAC address (vMAC).

In FIG. 2B, a physical host machine 12″ includes an operating system 40 in communication with the network switch 16 through a multi-queue NIC 42. In general, a multi-queue NIC 42 is a NIC with hardware support for network virtualization. Typically, multi-queue NICs have a plurality of sets of transmit and receive queues 44. Each queue 44 is dedicated to a specific entity (virtualized or non-virtualized) on the physical host machine 12″ through the assigning of a MAC address to that queue. In this embodiment of a virtualized host environment, the queues 44 of the multi-queue NIC 42 illustrate examples of virtualized entities 18 (FIG. 1).

The embodiment of virtualized host environment provided by a physical host machine 12′″ of FIG. 2C includes a combination of the virtualization technologies shown in FIG. 2A and FIG. 2B. More specifically, the physical host machine 12′″ includes virtualization software, with the hypervisor 30 producing one or more virtual machines 32, in communication with the network switch 16 through the multi-queue NIC 42. In this embodiment, each virtual machine 32, the hypervisor 30, and the queues 44 of the multi-queue NIC 42 are examples of virtualized entities 18 (FIG. 1).

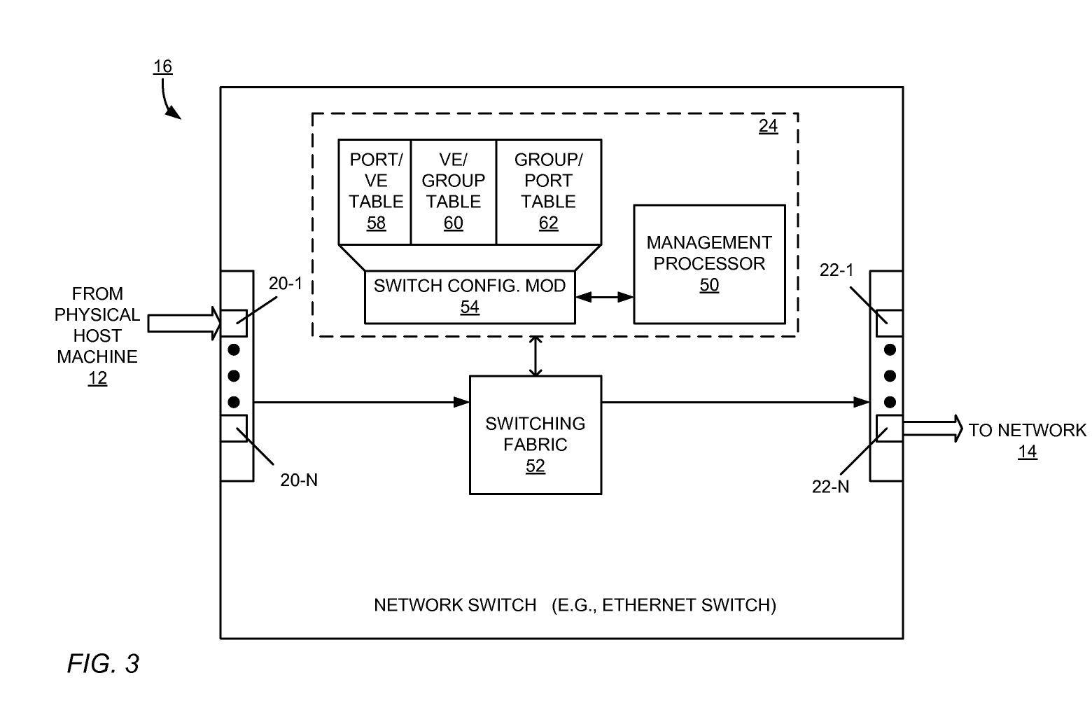

FIG. 3 shows a functional block diagram of an embodiment of the network switch 16 of FIG. 1 including a plurality of downlink ports 20-1, 20-N (generally, 20), a plurality of uplink ports 22-1, 22-N (generally, 22), and a switching fabric 52 for switching packets between the ports 20, 22. The switching fabric 52 is a physical layer 2 switch that dispatches packets in accordance with the VE groups and the traffic-handling policies associated with the groups. In general, the switching fabric 52 can be embodied in a custom integrated circuit (IC), such as an application-specific integrated circuit (ASIC) or field-programmable gate array (FPGA).

The management module 24 (FIG. 1) of the network switch 16 is in communication with the switching fabric 52 to affect the switching behavior of the switching fabric 52, as described herein. Although shown as separate from the switching fabric 52, the management module 24 can be implemented within an ASIC or FPGA along with the switching fabric 52. For purposes of communicating with a physical host machine, the management module 24 can communicate through the switching fabric 52 and the appropriate physical downlink port 20.

The management module 24 includes a management processor 50 that communicates with a switch configuration module 54. In one embodiment, the switch configuration module 54 is a software program executed by the management processor 50 to give the network switch its awareness of server virtualization, as described herein. Alternatively, the switch configuration module 54 may be implemented in firmware.

In brief overview, the switch configuration module 54 configures the network switch 16 to be aware of the existence and identity of virtualized entities operating on those physical host machines 12 to which the downlink ports 20 are connected. In addition, the switch configuration module 54 enables an administrator to define groups, associate such groups with traffic-handling policies, and to place virtualized entities into such groups.

More specifically, the switch configuration module 54 enables: (1) the grouping of virtualized entities of similar function (e.g., database servers in one VE group, finance servers in another VE group, web servers in yet another VE group); (2) the application of network policies on a VE-group basis (such as best effort QoS to web server virtual machines and guaranteed QoS to database server virtual machines); (3) distributed (across multiple network switches) and redundant uplink connectivity per group of virtualized entities across multiple physical host machines such that a network switch appears as an end-host (server) multi-homed NIC to upstream network elements; (4) failover and redundancy per VE group, so that on a failover the applicable traffic-handling policy moves to a backup VE group, making a VE failover transparent to upstream network elements; (5) service-oriented security for network traffic across different VE groups (e.g., traffic to web server virtual machines are segregated from traffic to finance server virtual machines); and (6) service-level and application-aware health checks to provide failover and redundancy at the VE-granular level, and not just at the physical hardware level.

The switch configuration module 54 employs various data structures (e.g., tables) for maintaining associations among virtualized entities, groups, and ports. A first table 58 maintains associations between downlink ports 20 and virtualized entities, a second table 60 maintains associations between virtualized entities and groups, and a third table 62 maintains associations between groups and uplink ports 22. Although shown as separate tables, the tables 58, 60, 62 can be embodied in one table or in different types of data structures.

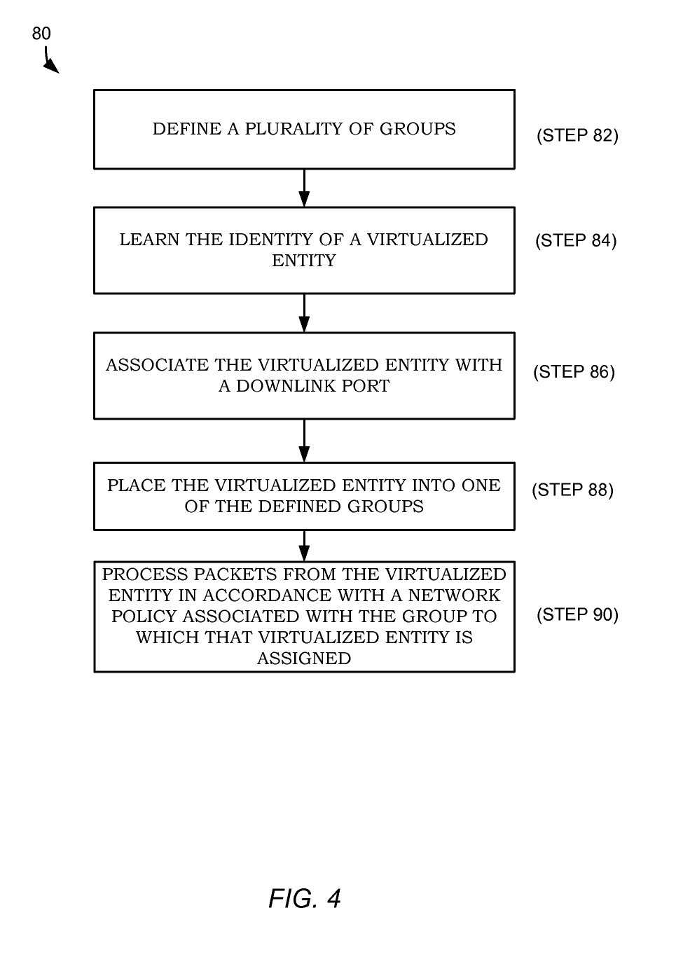

FIG. 4 shows an embodiment of a general process 80 for configuring the network switch 16 to be aware of virtualized entities operating on physical host machines. The order of steps is an illustrative example. Some of the steps can occur in a different order from that described. At step 82, an administrator of the network switch 16 defines a plurality of groups. In one embodiment, groups generally correspond to predefined network policies, are allocated resources of the network switch, such as bandwidth, and dedicated to specific uplink ports 22. The group-to-ports table 62 can maintain the assignments of the groups to uplink ports.

At step 84, the network switch 16 acquires the identity of a virtualized entity and associates (step 86) the virtualized entity with a downlink port 20. The port-to-VE table 58 maintains this association. An administer assigns (step 88) the virtualized entity to one of the defined groups. The VE-to-group table 60 can hold this assignment.

After being configured to be aware of a particular virtualized entity, the network switch 16 can detect when ingress packet traffic is coming from or addressed to the virtualized entity. Upon receiving packet traffic on a downlink port 20 related to the virtualized entity, the switching fabric 52 processes (step 90) the traffic in accordance with the network policy associated with the group in which the virtualized entity is a member. If in processing the packet traffic the switching fabric 52 determines to the forward the packet traffic to an upstream network element, the switching fabric 52 selects the particular uplink port 22 dedicated to the group in which the virtualized entity is a member.

### Learning of a Virtualized Entity

The network switch 16 can learn of a virtualized entity in one of three manners: (1) the network switch can learn the identity of a virtualized entity from packet traffic received on a downlink port; (2) the network switch can directly query the virtualized entity for identifying information; or (3) an administrator can directly enter the information identifying the virtualized entity into the management module.

Packets arriving at a downlink port 20 have various fields for carrying information from which the network element can detect and identify a virtualized entity from which the packet has come. One such field holds the Organizationally Unique Identifier (OUI). Another such field is the source address. In brief, the network switch extracts the OUI from a received packet and determines whether that OUI is associated with a vender of virtualization software. For example, hexadecimal values 00-0C-29 and 00-50-56 are associated with VMware, hexadecimal value 00-16-3E is associated with XenSource, hexadecimal value 00-03-FF is associated with Microsoft, and hexadecimal value 00-0f-4B is associated with Virtual Iron, and hexadecimal value 00-18-51 is associated with SWsoft.

If, based on the OUI value, the network switch determines that the packet is from a virtualization software vendor, the network switch extracts the address from the source address field of the packet. This address serves to identify the virtualized entity. For a virtual machine, this address is a unique virtual MAC address of the vNIC of that virtual machine. For a multi-queue NIC, this address is a unique MAC address associated with one of the queues of that multi-queue NIC. In virtualized host environments having both virtual machines and multi-queue NICs, the network switch can use either the vMAC address of the vNIC or the MAC address of a queue to identify the virtualized entity. The network switch places the virtual MAC (or MAC) address into the port-VE table 58, associating that address with the downlink port on which the packet arrived.

Instead of eavesdropping on incoming packet traffic to detect and identify a virtualized entity, the network element can directly query the virtualized entities operating on a physical host machine to acquire attribute information. The network element can use one of a variety of attribute-gathering mechanisms to send an information request to a driver of a virtual machine, hypervisor, or multi-queue NIC. Examples of such attribute-gathering mechanisms include, but are not limited to proprietary and non-proprietary protocols, such as CIM (Common Information Model), and application program interfaces (APIs), such as VI API for VMware virtualized environments. Examples of attributes that may be gathered include, but are not limited to, the name of the virtualized entity (e.g., VM name, hypervisor name), the MAC or vMAC address, and the IP (Internet Protocol) address of the VM or hypervisor. The network switch places the virtual MAC (or MAC) address into the port-VE table 58, associating that address with the downlink port on which the packet arrived.

Alternatively, the administrator can directly configure the management module 24 of the network element with information that identifies the virtualized entity. Typically, an administrator comes to know the vMAC addresses of the vNICs (or MAC addresses of the queues of a multi-queue NIC) when configuring a virtualized host environment on a physical host machine. This address information can be entered into the network switch before the virtualized entity begins to transmit traffic.

### Grouping Virtualized Entities

Typically, administrators of a data center tend to place servers that perform a similar function (application or service) into a group and apply certain policies to this group (and thus to each server in the group). Such policies include, but are not limited to, security policies, storage policies, and network policies. Reference herein to a “traffic-handling policy” contemplates generally any type of policy that can be applied to traffic related to an application or service. In contrast, reference herein to a “network policy” specifically contemplates a network layer 2 or layer 3 switching configuration on the network switch, including, but not limited to, a VLAN configuration, a multicast configuration, QoS and bandwidth management policies, ACLs and filters, security and authentication policies, a load balancing and traffic steering configuration, and a redundancy and failover configuration. Although described herein primarily with reference to network policies, the principles described herein generally apply to traffic-handling policies, examples of which include security and storage policies.

Administrators apply network policies to virtualized entities on a group basis, regardless of the physical location of the virtualized entity or the particular downlink port 20 by which the virtualized entity accesses the network switch 16. For example, an administrator may place those servers or virtual machines performing database functions into a first VE group, while placing those servers or virtual machines performing web server functions into a second VE group. To the first VE group the administrator can assign high-priority QoS (quality of service), port security, access control lists (ACL), and strict session-persistent load balancing, whereas to the second VE group the administrator can assign less stringent policies, such as best-effort network policies. Furthermore, the administrator can use VE groups to isolate traffic associated with different functions from each other, thereby securing data within a given group of servers or virtual machines. Moreover, the network switch 16 can ensure that virtualized entities belonging to one VE group cannot communicate with virtualized entities belonging to another VE group.

An administrator further associates groups with specific network resources including, for example, bandwidth. In addition, each group is assigned an optional given uplink port 22 of the network switch 16, through which the switching fabric 52 forwards traffic from the virtualized entities belonging to that group toward their destinations. More than one group may be assigned the same uplink port.

Any number of different VE groups may be defined. A given VE group can be comprised of a single physical host machine, a single virtual machine, or a single queue in a multi-queue NIC. Such group assignments enable the network switch to operate at a virtual machine granularity, a queue granularity, at a physical machine granularity, or at a combination thereof.

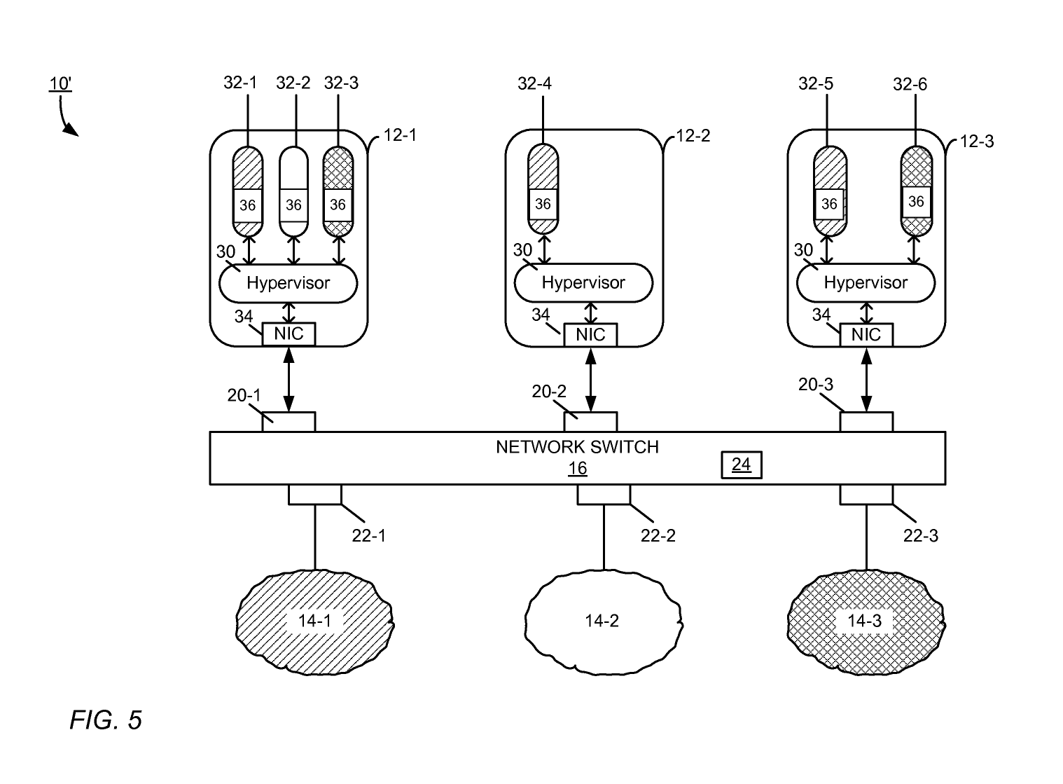

As an example illustration of grouping, FIG. 5 shows an embodiment of a data center 10′ with three physical host machines 12-1, 12-2, 12-3 (generally, 12) in communication with the network switch 16. Each physical host machine 12 is directly connected to a different one of the downlink ports 20. More specifically, physical host machine 12-1 is directly connected to the downlink port 20-1, physical host machine 12-2 is directly connected to the downlink port 20-2, and physical host machine 12-3 is directly connected to the downlink port 20-3.

In this illustrated embodiment, the hypervisor 30 of physical host machine 12-1 generates individual virtual machines 32-1, 32-2, and 32-3; physical host machine 12-2 is running virtual machine 32-4; and physical host machine 12-3 is running virtual machines 32-5 and 32-6. Consider, for illustration purposes, that the application programs running on virtual machines 32-1, 32-4, and 32-5 are database application programs, those running on virtual machines 32-3 and 32-6 are web server application programs, and the application running on virtual machine 32-2 is an engineering application program. Each virtual machine 32 has a virtual NIC (vNIC) 36, each having an associated virtual MAC address (vMAC).

The uplink ports 22 connect the network switch 16 to a plurality of networks 14-1, 14-2, 14-3 (generally, 14), each uplink port 22 being used to connect to a different one of the networks. Specifically, the network 14-1 is connected to uplink port 22-1; network 14-2, to uplink port 22-2; and network 14-3, to uplink 22-3. Examples of networks 14 include, but are not limited to, finance Ethernet network, engineering Ethernet network, and operations Ethernet network. Although shown as separate networks 14-1, 14-2, 14-3, these networks can be part of a larger network. Also for illustration purposes, consider that the network 14-1 is the target of communications from the database applications running on virtual machines 32-1, 32-4, and 32-5, that the network 14-2 is the target of communications from the engineering application running on the virtual machine 32-2, and that the network 14-3 is the target of communications from the web server applications running on virtual machines 32-3 and 32-6. In FIG. 5, similar shading of the virtual machines 32 and networks 14 shows this association.

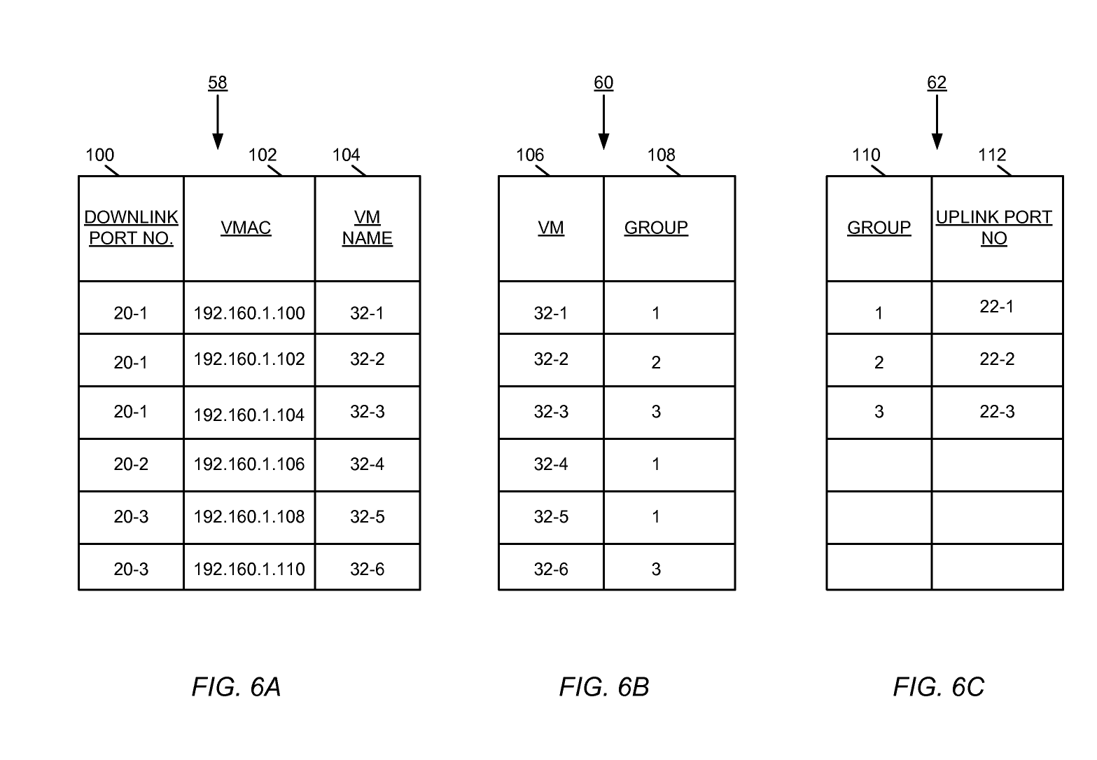

During the operation of the data center 10′, the management module 24 of the network switch 16 becomes aware of the identities of the virtual machines 32 (through one of the means previously described) running on the various physical host machines 12. Each virtual machine 32 is associated with the downlink port 20 to which the physical host machine 12 is directly connected. FIG. 6A shows an example of a port-VE table 58 that can result from this association of virtual machines 32 to downlink ports 20. A first column 100 of the table 58 identifies the downlink port 20, a second column 102 identifies a virtual machine (e.g., by name), and a third column 104 identifies an address (in this instance, a vMAC). As an illustrative example, the port-VE table 58 shows that each of the three virtual machines 32-1, 32-2, and 32-3 are associated with the downlink port 20-1.

The administrator configures the management module 24 to place the virtual machines 32-1, 32-4, and 32-5 into a first group because of their common functionality (database access), the virtual machine 32-2 into a second group, and the virtual machines 32-3 and 32-6 into a third group because of their common functionality (web server). FIG. 6B shows an example of a VE-group table 60 that can result from this placement of virtual machines 32 into groups. A first column 106 identifies the virtual machine (e.g., again, by name) and a second column 108 identifies the group into which each virtual machine is placed. As an illustrative example, the VE-group table 60 shows that each of the three virtual machines 32-1, 32-4, and 32-5 has been placed into the first group (labeled group no. 1), and access the network switch on three different downlink ports. As an aside, not only does downlink port 20-1 serve as a point of access for three different virtual machines, but also it processes traffic associated with three different groups.

In addition, the administrator configures the management module 24 to assign each defined group to one of the uplink ports 20. FIG. 6C shows an example of a group-port table 62 that can result from this assignment of groups to uplink ports 22. A first column 110 identifies the group and a second column 112 identifies the uplink port 22 to which each group is assigned. As an illustrative example, the group-port table 62 shows that group no. 3 is assigned to uplink port 22-3.

After the configuration of the network switch 16, as described above, packets are switched at the granularity of a single virtual machine (in contrast to being switched at a coarser granularity of a single physical host machine or of a single downlink port). For instance, whereas packets from both virtual machines 32-1 and 32-3 running on the same physical host machine 12-1 arrive at the same downlink port 20-1, because of the above-described configuration, the network switch 16 can separate the packets at a virtual machine granularity, forwarding those packets from virtual machine 32-1 to uplink port 22-1 and those packets from virtual machine 32-3 to uplink port 22-3.

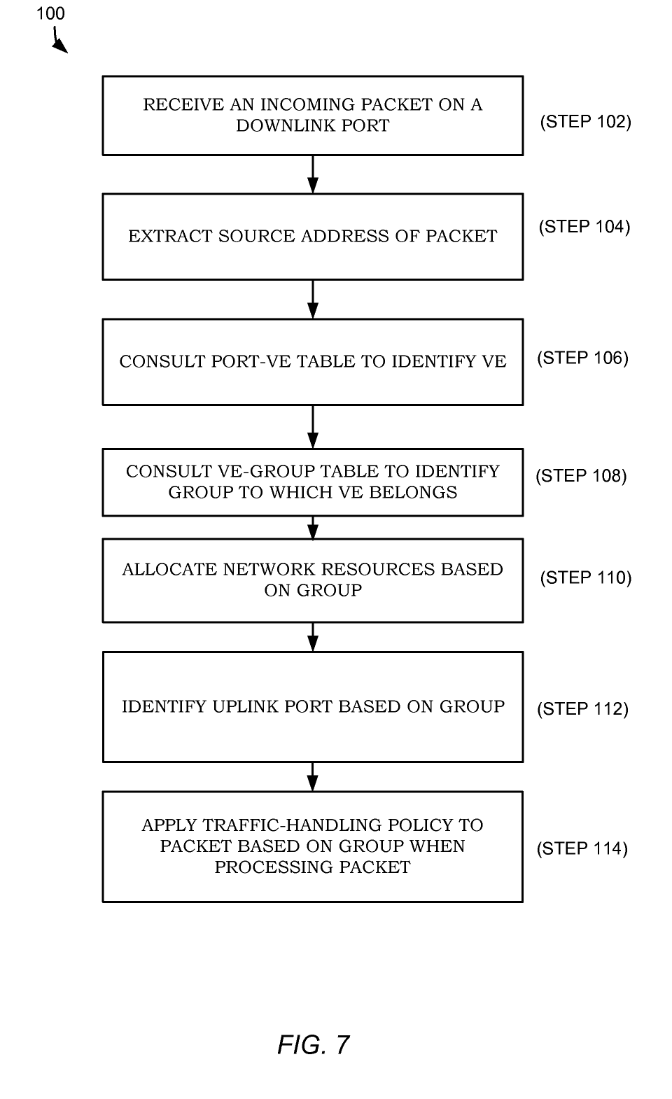

FIG. 7 shows an example of a process 100 by which the network switch 16 forwards packets based on its VE-group configuration. Again, the order of steps is an illustrative example; some of the steps can occur in a different order from that described. At step 102, the network switch 16 receives an incoming packet on one of its downlink ports 20. The management module 24 of the network switch extracts (step 104) an address from the source address field of the packet and searches the port-VE table 58 for the extracted address. If the network switch is already aware of the virtualized entity sending the packet, the address of the virtualized entity is currently present in the port-VE table 58 (although the address may currently be associated in the port-VE table 58 with a different physical port from the physical downlink port at which the packet arrived, signifying that the virtualized entity has moved to a different physical host machine).

Presuming that the address of the virtualized entity is currently in the port-VE table 58 and currently recorded as associated with the downlink port at which the packet arrived, the network switch identifies (step 106) the virtualized entity. Using the identified virtualized entity, the network switch searches the VE-group table 60 to identify (step 108) the group to which the virtualized entity is assigned. After identifying the group, the network switch allocates (step 110) any network resources associated with the group, acquires (step 112) the identity of the uplink port assigned to the group from the group-port table 62, and applies (step 114) the traffic-handling policy associated with the group to the packet when forwarding the packet to the acquired uplink port.

If the address of the virtualized entity is currently in the port-VE table 58, but it appears associated with a different downlink port, then the virtualized entity has moved to a different physical host machine. The management module updates the port-VE table 58 to reflect the present association between the virtualized entity and the present physical downlink port being used to access the network switch. The virtualized entity remains a member of its previously assigned group and continues to receive the same network resources and undergo the same traffic-handling policy that it was previously assigned.

If the address of the virtualized entity is not currently in the port-VE table 58, the management module 24 may have discovered a new virtualized entity. The management module 24 can then add the VMAC or MAC address of the virtualized entity to the port-VE table 58 and prompt the administrator to assign the virtualized entity to a group. After the virtualized entity becomes a member of a group, the network element can process traffic from the virtualized entity in accordance with the traffic-handling policy associated with that group.

### VLAN

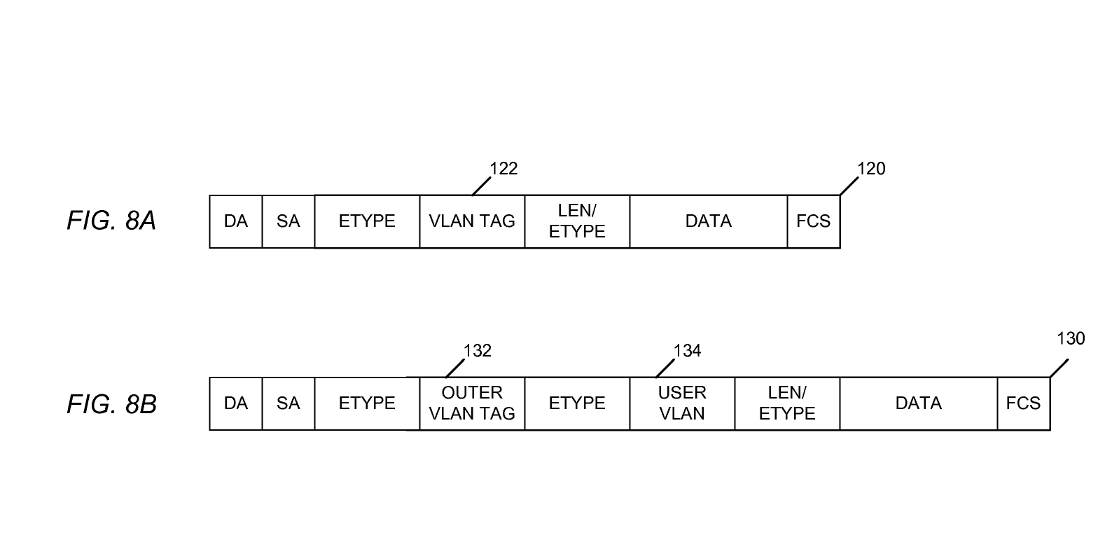

One approach for implementing grouping is to use VLANs (virtual LANs) to group the virtualized entities of similar function. If the network switch is VLAN-aware, the VLAN tag (IEEE 802.1Q) can serve to identify the group. FIG. 8A shows an example of an 802.1q frame or packet 120 having a VLAN tag 122. An administrator can place virtual machines into VLANs for purposes of departmental separation and resource allocation, and the network switch uses the VLAN tag as a group identifier for purposes of applying the network policies to traffic coming from these virtual machines based on the VLAN (i.e., group) identifier. The physical downlink ports are enabled for tagging so that the network switch can accept packets with specified VLAN tags.

For a VLAN-agnostic (i.e., VLAN-transparent) network switch, a Q-in-Q VLAN tag (IEEE 802.1 Q-in-Q) can be used to identify the group, while the inner VLAN tag represents a user's virtual LAN and remains transparent to the network switch. FIG. 8B shows an example of an 802.1q-in-q packet 130 having an outer VLAN tag 132 and an inner VLAN tag 134. The outer VLAN tag 132 identifies the VE group; the inner VLAN tag 134 identifies the user VLAN. The network switch uses the outer VLAN tag 132 (i.e., VE group identifier) to determine which network policies to apply to the packet, whereas the inner VLAN tag remains transparent to the network switch. The outer VLAN tag has local significance to the network switch and, in general, is not seen beyond the physical downlink and uplink ports associated with the group (signified by the outer VLAN tag). The outer VLAN tag is added at the ingress port (downlink or uplink) in accordance with the rules associated with the group and removed at the egress port (uplink or downlink) before the packet leaves the network switch.

To translate between VLANs and virtualized entities, the network switch can use a translation table (e.g., the VE-group table 60) to associate VLAN tag values (whether an inner VLAN tag or outer VLAN tag) with MAC addresses of the virtualized entities. Alternatively, intelligent filters or ACLs can be used to translate between VLAN tag values (inner or outer VLAN tags) and the MAC addresses of the virtualized entities. As another alternative, the attribute-gathering mechanisms described above, namely, the CIM or proprietary APIs and protocols for acquiring attribute information about a virtualized entity, can be used to translate between virtualized entities and VM-granular network policies.

To accommodate the use of VLANs for identifying groups of virtualized entities, the network switch has a VLAN-based configuration engine for all network policies so that the network switch can provide group-based (VE-granular) configuration and network policies.

### Mixed Mode Granularity

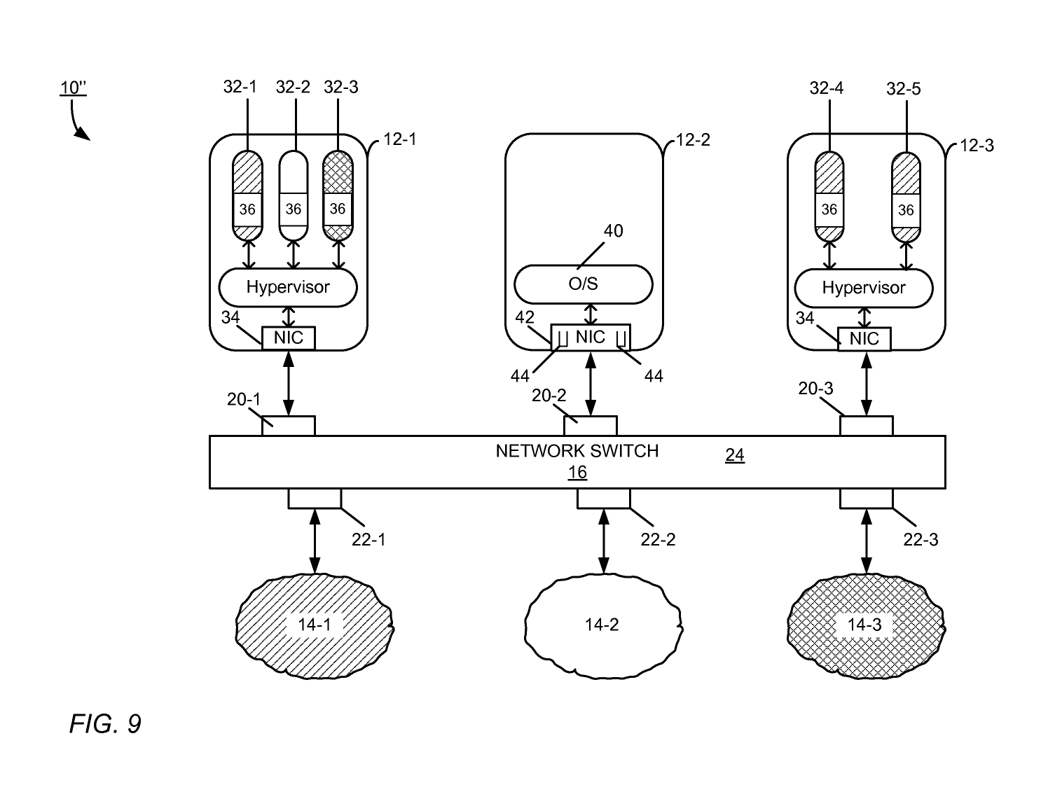

As described previously, a given group can be comprised of a single physical host machine, a single virtual machine, or a single queue in a multi-queue NIC. As shown in FIG. 9, a data center can simultaneously manage traffic-handling policies associated with groups defined at a virtual machine granularity, at a queue granularity, and at a physical machine granularity. For example, the data center 10″ has three physical host machines 12-1, 12-2, 12-3, each directly connected to a different downlink port 20 of the network switch 16. The physical host machine 12-1 provides a virtualized host environment comprised of three virtual machines 32-1, 32-2, and 32-3 executing three different applications or services (indicated by the different types of shading), the physical host machine 12-2 provides a virtualized host environment comprised of a multi-queue NIC 42, and the physical host machine 12-3 provides a virtualized host environment comprised of two virtual machines 32-4 and 32-5 performing a similar type of application or service.

During the operation of the data center 10″, the management module 24 of the network switch 16 becomes aware of the identities of the virtual machines 32-1, 32-2, 32-3, 32-4, and 32-5 and of each queue 44 of the multi-queue NIC 42. Each virtualized entity (i.e., virtual machine and queue) is associated with the downlink port 20 to which the physical host machine 12 is directly connected.

The administrator configures the management module 24 to place the virtual machine 32-1 into a first VE group, the virtual machine 32-2 into a second VE group, and the virtual machine 32-3 into a third VE group, a queue of the multi-queue into a fourth VE group, and the entire physical host machine 12-3 into a fifth VE group. Alternatively, the administrator can place the virtual machines 32-4 and 32-5 in the first group with the virtual machine 32-1 because these virtual machines perform a similar function (as denoted by their shading). In addition, the administrator configures the management module 24 to assign each defined group to one of the uplink ports 22. An uplink port 22 can be shared by multiple groups or be exclusively dedicated to one group in particular. After the configuration of the network switch 16, as described above, packets are switched at the granularity of a single virtual machine (as is done for virtual machines 32-1, 32-2, and 32-3), at the granularity of a single queue, and at the granularity of a single physical host machine.

### Scalability

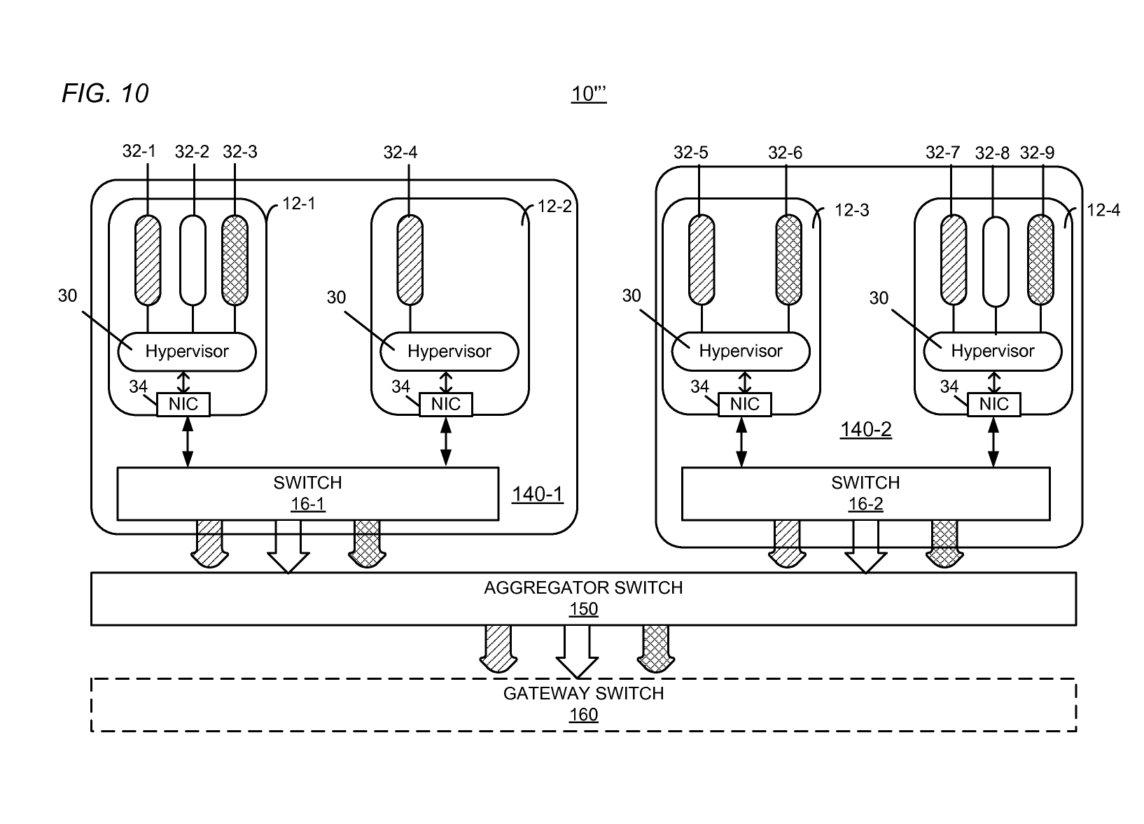

The practice of grouping virtualized entities and applying network policies on a group basis can scale beyond the network switch 16. Groups can span multiple tiers of a network topology tree and, hence, enable the deployment of group-based network policies and fine-grained network resource control throughout the data center. As an illustrative example of such scalability, FIG. 10 shows a data center 10′″ having four physical host machines 12-1, 12-2, 12-3, 12-4; physical host machines 12-1 and 12-2 are directly connected to different downlink ports of a first network switch 16-1 and physical host machines 12-3 and 12-4 are directly connected to different downlink ports of a second network switch 16-2. The physical host machines 12-1 and 12-2 and network switch 16-1 are co-resident in a first chassis 140-1, and the physical host machines 12-3 and 12-4 and network switch 16-2 are co-resident in a second chassis 140-2.

Each network switch 16-1, 16-2 is virtualization-aware, places VEs into groups, and applies network policies to VE traffic based on the groups. In FIG. 10, the shading of the virtual machines indicates the group to which the virtual machine belongs. For example, both network switches 16-1, 16-2 can place content servers into one group, security servers into another group, and authorization servers within a third group. (The groups are defined consistently across the network elements to facilitate grouping at the aggregator switch.) Each group is associated with an uplink port of the network switch.

Each network switch 16-1, 16-2 is connected to an aggregator switch 150. The aggregator switch 150 can be in the same chassis as one of the network switches or in a chassis separate from the network switches. In one embodiment, the aggregator switch 150 is in communication with a gateway switch 160.

To support a network policy management across the entire data center at a VE granularity, the aggregator switch 150 and, optionally, the gateway 160 also become VE group-based. One approach to extend VE groups to upstream network elements in the data center (i.e., to aggregator and gateway switches) is for the aggregator switch 150 to run a control protocol that communicates with the network switches to acquire the group attributes and the group-to-uplink port assignments made at those network switches and to pass such information to the gateway switch 160. Examples of attributes acquired for a given group include the VE group identifier, members of the VE group, uplink bandwidth for the VE group, and ACLs associated with the VE group. Alternatively, the data packets passing from the network switches to the aggregator switch can carry the group attributes (e.g., within the 802.1Q tag or 802.1q-in-Q tag). In addition, the aggregator switch 150 assigns groups to its uplink ports, and consequently appears as a multi-homed NIC to its upstream network elements (e.g., the gateway switch 160).

Embodiments of the described invention may be implemented in hardware (digital or analog), software (program code), or combinations thereof. Program code implementations of the present invention may be embodied as computer-executable instructions on or in one or more articles of manufacture, or in or on computer-readable medium. A computer, computing system, or computer system, as used herein, is any programmable machine or device that inputs, processes, and outputs instructions, commands, or data. In general, any standard or proprietary, programming or interpretive language can be used to produce the computer-executable instructions. Examples of such languages include C, C++, Pascal, JAVA, BASIC, Visual Basic, and C#.

Examples of articles of manufacture and computer-readable medium in which the computer-executable instructions may be embodied include, but are not limited to, a floppy disk, a hard-disk drive, a CD-ROM, a DVD-ROM, a flash memory card, a USB flash drive, an non-volatile RAM (NVRAM or NOVRAM), a FLASH PROM, an EEPROM, an EPROM, a PROM, a RAM, a ROM, a magnetic tape, or any combination thereof. The computer-executable instructions may be stored as, e.g., source code, object code, interpretive code, executable code, or combinations thereof.

While the invention has been shown and described with reference to specific preferred embodiments, it should be understood by those skilled in the art that various changes in form and detail may be made therein without departing from the spirit and scope of the invention as defined by the following claims.

What is claimed is:

1. A data center comprising:
a first physical host machine operating one or more virtualized entities;
a second physical host machine operating one or more virtualized entities;
a network switch having a first physical port connected to the first physical host machine, a second physical port connected to the second physical host machine, and a management module that acquires information about each virtualized entity operating on the physical host machines, uses the information to associate each virtualized entity with the physical port to which the physical host machine operating that virtualized entity is connected, assigns each virtualized entity to a group, and associates each group with a traffic-handling policy; and
a switching fabric processes packet traffic received from each of the virtualized entities based on the traffic-handling policy associated with the group assigned to that virtualized entity.

2. The data center of claim 1, wherein at least one of the physical ports of the network switch receives packet traffic from virtualized entities assigned to a plurality of different groups.

3. The data center of claim 1, wherein at least one of the virtualized entities operating on the first physical host machine and at least one of the virtualized entities operating on the second physical host machine are assigned to the same group.

4. A data center comprising:
a physical host machine operating a virtualized entity; and
a network switch having a physical port connected to the physical host machine and a management module that acquires information about the virtualized entity operating on the physical host machine and uses the information to associate the virtualized entity with the physical port and to detect when packet traffic arriving at the network switch is coming from the virtualized entity.

5. The data center of claim 4, wherein the management module acquires the information about the virtualized entity by extracting the information from a field in a packet received from the physical host machine on the physical port.

6. The data center of claim 4, wherein the management module acquires the information about the virtualized entity in a reply from the physical host machine received in response to a query sent by the management module to gather information about the virtualized entity.

7. The data center of claim 4, wherein the management module acquires the information about the virtualized entity from input provided by an administrator.

8. The data center of claim 4, wherein the network switch further comprises a configuration module that associates groups with traffic-handling policies and assigns the virtualized entity to one of the groups in order to assign the traffic-handling policy associated with that assigned group to the virtualized entity.

9. The data center of claim 8, wherein a VLAN (virtual LAN) tag in packets from the virtualized entity identifies the group assigned to the virtualized entity.

10. The data center of claim 9, wherein the VLAN tag is an IEEE 802.1Q-in-Q outer VLAN tag.

11. The data center of claim 8, wherein the network switch further comprises a switching fabric that applies the traffic-handling policy associated with the group assigned to the virtualized entity to packet traffic from the virtualized entity.

12. The data center of claim 8, wherein the network switch includes a second physical port, and further comprising an aggregator switch electrically connected to second physical port of the network switch to receive therefrom information about the group assigned to the virtualized entity.

13. The data center of claim 12, further comprising a gateway switch in communication with the aggregator switch to receive therefrom the information about the group assigned to the virtualized entity.

14. The data center of claim 4, wherein the virtualized entity is a virtual machine running on the physical host machine.

15. The data center of claim 14, wherein the virtual machine has a virtual network I/O card (NIC) that has an associated virtual MAC (media access control) address and the information acquired by the network switch includes the virtual MAC address of the virtual NIC.

16. The data center of claim 4, wherein the virtualized entity is a queue of multi-queue network input/output (I/O) card.

17. The data center of claim 16, wherein the queue has an associated MAC address and the information acquired by the network switch includes the MAC address of the queue.

18. A network switch comprising:
a physical port connected to a physical host machine that is operating a virtualized entity; and
a management module in communication with the physical host machine through the physical port, the management module acquiring information about the virtualized entity operating on the physical host machine and using the information to associate the virtualized entity with the physical port and to detect when ingress packet traffic is coming from the virtualized entity.

19. The network switch of claim 18, wherein the management module acquires the information about the virtualized entity by extracting the information from a field in a packet received from the physical host machine on the physical port.

20. The network switch of claim 18, wherein the management module acquires the information about the virtualized entity in a reply from the physical host machine received in response to a query sent by the management module to learn about the virtualized entity.

21. The network switch of claim 18, wherein the management module acquires the information about the virtualized entity from input provided by an administrator.

22. The network switch of claim 18, wherein the network switch further comprises a configuration module that associates groups with traffic-handling policies and assigns the virtualized entity to one of the groups in order to assign the traffic-handling policy associated with that assigned group to the virtualized entity.

23. The network switch of claim 22 wherein a VLAN (virtual LAN) tag in packet traffic from the virtualized entity identifies the group assigned to the virtualized entity.

24. The network switch of claim 23, wherein the VLAN tag is an IEEE 802.1Q-in-Q outer VLAN tag.

25. The network switch of claim 22, wherein the network switch further comprises a switching fabric that applies the traffic-handling policy associated with the group assigned to the virtualized entity to packet traffic from the virtualized entity.

26. The network switch of claim 18, wherein the virtualized entity is a virtual machine running on the physical host machine.

27. The network switch of claim 26, wherein the virtual machine has a virtual network I/O card (NIC) with an associated virtual MAC (media access control) address and the information acquired by the network switch includes the virtual MAC address of the virtual NIC.

28. The network switch of claim 18, wherein the virtualized entity is a queue of multi-queue network input/output (I/O) card.

29. The network switch of claim 28, wherein the queue has an associated MAC address and the information acquired by the network switch includes the MAC address of the queue.

30. A method of configuring a network switch to process packet traffic from a virtualized entity operating on a physical host machine connected to a physical port of the network switch, the method comprising:
acquiring, by the network switch, information about the virtualized entity operating on the physical host machine;
associating, by the network switch, the acquired information about the virtualized entity with the physical port;
assigning, by the network switch, the virtualized entity to a group associated with a traffic-handling policy; and
processing, by the network switch, packet traffic from the virtualized entity in accordance with the traffic-handling policy.

31. The method of claim 30, wherein the acquiring of the information about the virtualized entity includes extracting the information from a field in a packet received from the physical host machine on the physical port.

32. The method of claim 30, wherein the acquiring of the information about the virtualized entity includes sending a query from the network switch to the physical host machine to gather information about the virtualized entity.

33. The method of claim 30, wherein the acquiring of the information about the virtualized entity includes receiving the information from administrator-provided input.

34. The method of claim 30, further comprising identifying the group assigned to the virtualized entity using a VLAN (virtual LAN) tag in packet traffic from the virtualized entity.

35. The method of claim 34, wherein the VLAN tag is an IEEE 802.1Q-in-Q outer VLAN tag.

36. The method of claim 30, wherein the virtualized entity is a virtual machine running on the physical host machine.

37. The method of claim 36, wherein the virtual machine has a virtual network I/O card (NIC) with an associated virtual MAC (media access control) address and the information acquired by the network switch includes the virtual MAC address of the virtual NIC.

38. The method of claim 30, wherein the virtualized entity is a queue of multi-queue network input/output (I/O) card.

39. The method of claim 38, wherein the queue has an associated MAC address and the information acquired by the network switch includes the MAC address of the queue.
